(19) United States
(12) Patent Application Publication
(10) Pub. No.: US 2026/0243327 A1
(43) Pub. Date: Aug. 20, 2026

(54) DAMPING FORCE ADJUSTING DEVICE AND SHOCK ABSORBING DEVICE

(71) Applicant: Astemo, Ltd., Tokyo (JP)

(72) Inventors: Gota NAKANO, Hitachinaka-shi (JP); Chikara YANAGISAWA, Hitachinaka-shi (JP); Tomoaki SHINOZAKI, Hitachinaka-shi (JP); Ryuya SAITO, Hitachinaka-shi (JP)

(73) Assignee: Astemo, Ltd., Tokyo (JP)

(21) Appl. No.: 19/160,428

(22) PCT Filed: May 19, 2023
(86) PCT No.: PCT/JP2023/018847

§ 371 Date: Aug. 27, 2025

(51) Int. Cl. F16F 9/34; F16F 9/18; F16F 9/46

(52) U.S. Cl. CPC F16F 9/34; F16F 9/185; F16F 9/465; F16F 2222/12; F16F 2228/066; F16F 2232/08; F16F 2234/02

(57) ABSTRACT

The present invention provides a damping force adjusting device including: a control valve that is provided on a flow path through which a fluid flows and that varies the area of the flow path; a case member that houses the control valve and has a control seat in which is formed a through hole that can be closed by the control valve; a solenoid part that applies thrust to a pressing member that can come into contact with the side opposite to the side facing the control seat in the control valve; a coil spring having one end in contact with the control valve and the other end in contact with the pressing member; and a biasing member having one end in contact with the control valve and the other end fixed to the case member.

### CROSS-REFERENCE TO RELATED PATENT APPLICATIONS

This application is a U.S. National Phase Application under 35 U.S.C. § 371 of International Patent Application No. PCT/JP2023/018847 filed on May 19, 2023, the content of which is incorporated herein by reference in its entirety. The International Patent Application was published in Japanese on Nov. 28, 2024 as International Publication No. WO/2024/241407 under PCT Article 21(2).

### FIELD OF THE INVENTION

The present invention relates to a damping force adjusting device and a shock absorbing device.

### BACKGROUND OF THE INVENTION

For example, the damping valve described in Japanese Unexamined Patent Application Publication (Translation of PCT Application) No. 2011-525962 has a valve body member including a pressure control valve body that is left from and seated at the pressure control valve seat and an opening and closing valve body that is left from and seated at the opening and closing valve seat, the valve body member opening and closing the upstream and downstream sides of a pilot path. In addition, the damping valve described in Patent Document 1 has a disc spring that is mounted between a step and the valve body member, the disc spring separating the pressure control valve body from the pressure control valve seat and biasing the valve body member in the direction that the opening and closing valve body approaches the opening and closing valve seat, and a solenoid that can drive the valve body member against the biasing force of the disc spring. The damping valve, which supplies a current to the solenoid to act thrust on the valve body member and presses the pressure control valve member of the valve body member against the pressure control valve seat in opposition to the biasing force of the disc spring, is described.

### CITATION LIST

### Patent Literature

Patent Document 1: Japanese Unexamined Patent Application Publication (Translation of PCT Application) No. 2011-525962

### TECHNICAL PROBLEM

In the damping valve described in Japanese Unexamined Patent Application Publication (Translation of PCT Application) No. 2011-525962, when the current is supplied to the solenoid to act the thrust on the valve body member, the thrust of the solenoid is transmitted to a valve housing through a first spring as well as deforming the first spring. In other words, limited solenoid thrust is transmitted to parts that were not necessary for operation, and there was room for improvement.

An object of the present invention is to provide a damping force adjusting device, etc. with high thrust efficiency that reduces the waste of thrust in an actuator part.

### SUMMARY OF THE INVENTION

### Solution to Problem

The present invention completed under the above object provides a damping force adjusting device including: a valve body provided on a flow path through which a fluid flows and capable of changing an area of the flow path; a case member housing the valve body and including a valve seat with a through hole formed therein, the through hole capable of being closed by the valve body; an actuator part applying thrust to a movable member capable of contacting a side of the valve body opposite to a side thereof facing the valve seat; a first spring member having one end in contact with the valve body and the other end in contact with the movable member; and a second spring member having one end in contact with the valve body and the other end fixed to the case member.

### Advantageous Effects of Invention

According to the present invention, it is possible to increase the thrust efficiency of the actuator part.

### BRIEF DESCRIPTION OF THE DRAWINGS

FIG. 1 is a diagram showing an example of an overall configuration of a hydraulic shock absorbing device related to a first exemplary embodiment;

FIG. 2 is a diagram showing an example of a cross section of a damping force generation device in the first exemplary embodiment;

FIG. 3 is a diagram showing an example of a perspective cross section of a main valve part and a damping force adjusting part in the first exemplary embodiment;

FIG. 4 is a diagram showing an example of a partial cross section of the main valve part and the damping force adjusting part in the first exemplary embodiment;

FIG. 5 is a diagram showing an example of oil flow when the moving speed of a piston part is low in the state where a pressing force of a pressing member is minimized;

FIG. 6 is a diagram showing an example of the oil flow when the moving speed of the piston part is high in the state where the pressing force of the pressing member is minimized;

FIG. 7 is a diagram showing an example of the oil flow when the moving speed of the piston part is low in the state where the pressing force of the pressing member is maximized;

FIG. 8 is a diagram showing an example of the oil flow when the moving speed of the piston part is high in the state where the pressing force of the pressing member is maximized;

FIG. 9 is a diagram showing an example of the oil flow when the moving speed of the piston part is low in the state where a solenoid part is not energized;

FIG. 10 is a diagram showing an example of the oil flow when the moving speed of the piston part is high in the state where the solenoid part is not energized;

FIG. 11 is a diagram showing an example of an overall configuration of a damping force generation device related to a second exemplary embodiment;

FIG. 12 is a diagram showing an example of an overall configuration of a damping force generation device related to a third exemplary embodiment;

FIG. 13 is a diagram showing an example of a partial cross section of the damping force generation device in the third exemplary embodiment;

FIG. 14 is a diagram showing an example of a state where a biasing member is in contact with a first edge part and not in contact with a second edge part;

FIG. 15 is a diagram showing an example of a state where the biasing member is in contact with the first edge part and the second edge part;

FIG. 16 is a diagram showing an example of a state where a control valve is seated at a round; and

FIG. 17 is a diagram showing an example of the correlation between the current supplied to the solenoid part and each of the thrust of the solenoid part, the spring constant of the biasing member, and the opening amount of the control valve.

### DETAILED DESCRIPTION OF THE INVENTION

Hereinafter, exemplary embodiments according to the present invention will be described in detail with reference to attached drawings.

### First Exemplary Embodiment

### Configuration and Function of Hydraulic Shock Absorbing Device 1

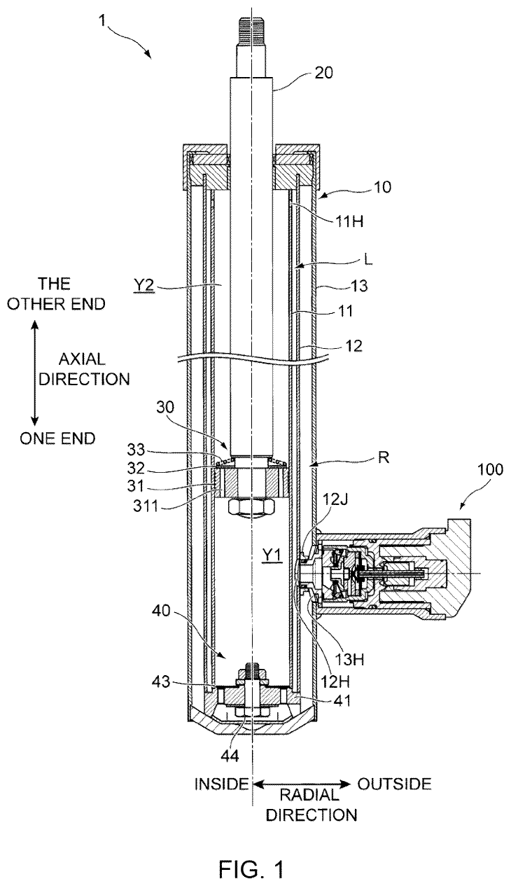

FIG. 1 is a diagram showing an example of an overall configuration of a hydraulic shock absorbing device 1 related to a first exemplary embodiment.

As shown in FIG. 1, the hydraulic shock absorbing device 1 includes a cylinder part 10 containing oil and a rod 20 with one end slidably inserted into the cylinder part 10 and the other end protruding from the cylinder part 10. In addition, the hydraulic shock absorbing device 1 includes a piston part 30 provided at one end of the rod 20 and a bottom part 40 provided at one end of the cylinder part 10. Furthermore, the hydraulic shock absorbing device 1 includes a damping force generation device 100 provided outside the cylinder part 10 to generate a damping force.

Note that, in the following description, the longitudinal direction of the cylinder part 10 shown in FIG. 1 is referred to as an “axial direction,” the lower side of FIG. 1 in the axial direction is referred to as “one side,” and the upper side of FIG. 1 is referred to as “the other side” in some cases. In addition, the left and right direction of the cylinder part 10 shown in FIG. 1 is referred to as the “radial direction,” and in the radial direction, the center axis side of the cylinder part 10 is referred to as “inside,” and the side away from the center axis is referred to as “outside” in some cases.

The cylinder part 10 includes a cylinder 11 containing oil, an outer cylindrical body 12 provided at the outside of the cylinder 11, and a damper case 13 provided further outside of the outer cylindrical body 12.

The cylinder 11 is formed cylindrically with a communicating hole 11H at an end part on the other side, which connects the inside and the outside.

The outer cylindrical body 12 is formed cylindrically. Then, the outer cylindrical body 12 forms a communication path L between the cylinder 11 and the outer cylindrical body 12. In addition, the outer cylindrical body 12 has an outer cylindrical body opening part 12H and an outer connection part 12J at a position facing the damping force generation device 100. The outer connection part 12J has an oil flow path and protrudes outward to form a connecting portion with the damping force generation device 100.

The damper case 13 is formed cylindrically. The damper case 13 forms a reservoir chamber R, in which oil accumulates, between the outer cylindrical body 12 and the damper case 13. The reservoir chamber R absorbs oil in the cylinder 11 or supplies oil into the cylinder 11 as the rod 20 moves relative to the cylinder 11. In addition, the reservoir chamber R also collects oil flowing from the damping force generation device 100. Moreover, the damper case 13 has a case opening part 13H at a position facing the damping force generation device 100.

The rod 20 is a rod-like member extending long in the axial direction. The rod 20 holds the piston part 30 on one side. In addition, the rod 20 connects to, for example, the vehicle body on the other side through a not-shown coupling member, etc.

The piston part 30 includes: a piston body 31 with plural piston oil ports 311; a piston valve 32 opening and closing the other side of the piston oil ports 311; and a spring 33 provided between the piston valve 32 and an end of the rod 20 on one side. Then, the piston part 30 divides the oil in the cylinder 11 into a first oil chamber Y1 and a second oil chamber Y2.

The bottom part 40 includes a valve seat 41, a check valve part 43 provided on the other side of the valve seat 41, and a fixing member 44 provided in the axial direction. Then, the bottom part 40 separates the first oil chamber Y1 and the reservoir chamber R.

### Configuration and Function of Damping Force Generation Device 100

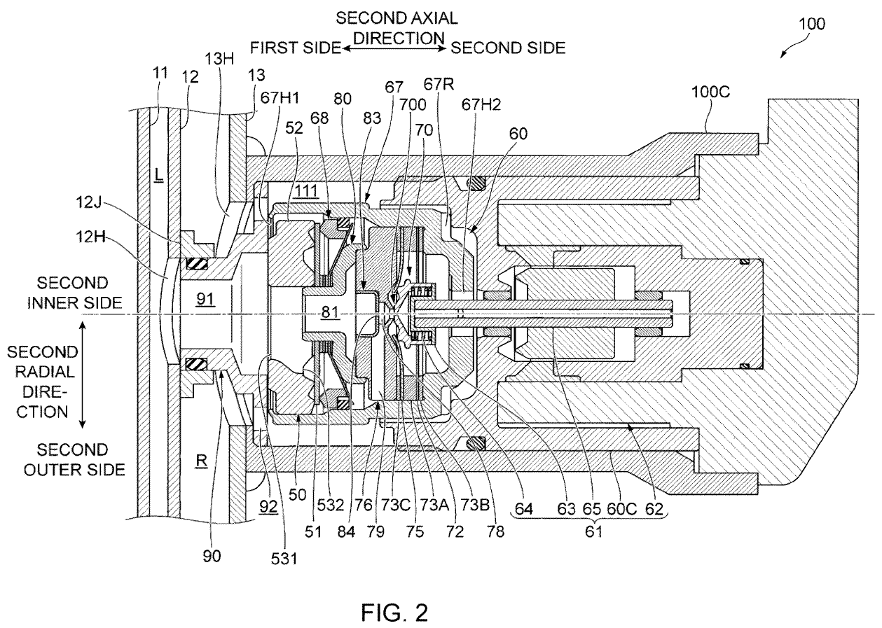

FIG. 2 is a diagram showing an example of a cross section of the damping force generation device 100 in the first exemplary embodiment.

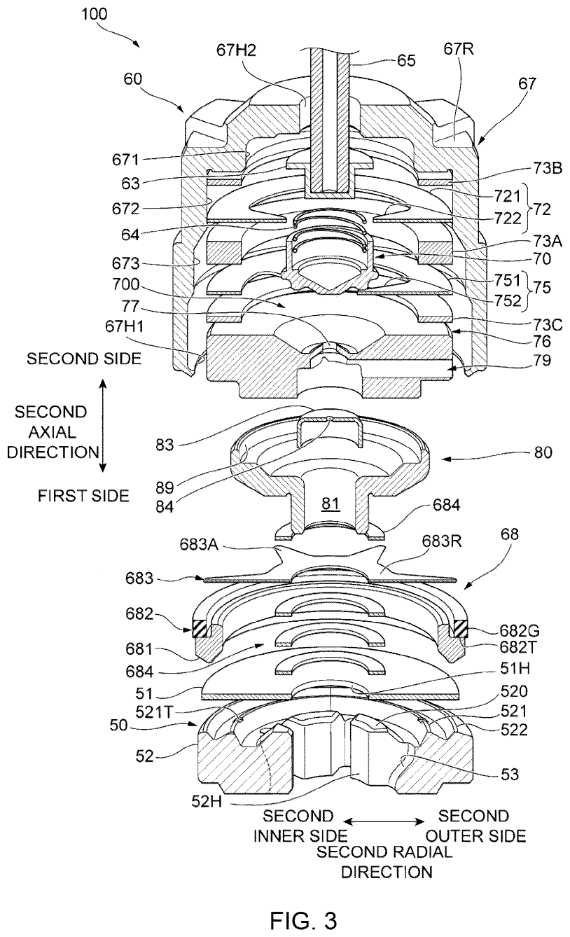

FIG. 3 is a diagram showing an example of a perspective cross section of a main valve part 50 and a damping force adjusting part 60 in the first exemplary embodiment.

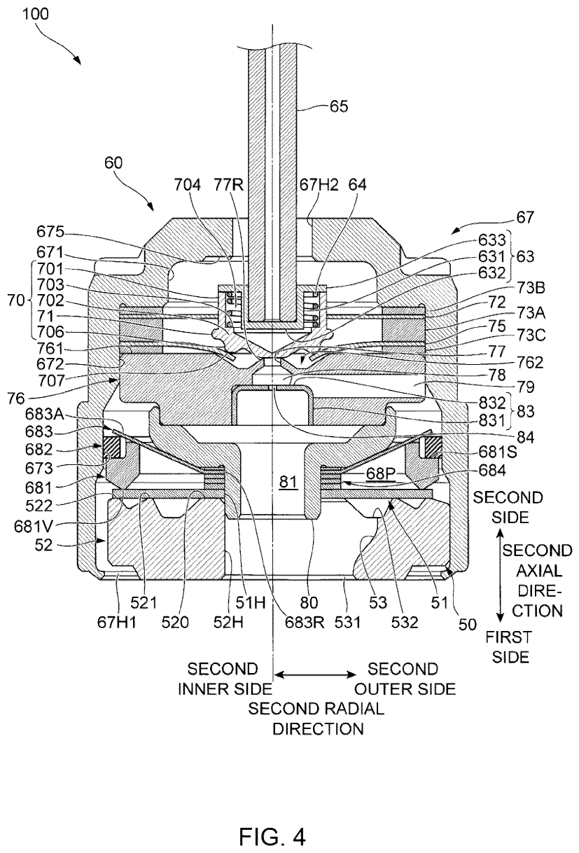

FIG. 4 is a diagram showing an example of a partial cross section of the main valve part 50 and the damping force adjusting part 60 in the first exemplary embodiment.

In the following description, the longitudinal direction of the damping force generation device 100 shown in FIG. 2 (that is, an intersecting direction intersecting the axial direction of the cylinder part 10 (refer to FIG. 1) (for example, substantially an orthogonal direction)) is referred to as a “second axial direction” in some cases. In addition, the center axis side of the cylinder part 10 (left side of the damping force generator 100 in FIG. 2) in the second axial direction is referred to as the “first side,” and the side away from the center axis of the cylinder part 10 (right side of the damping force generator 100 in FIG. 2) is referred to as the “second side” in some cases.

Moreover, the short direction of the damping force generation device 100 shown in FIG. 2 (that is, a direction intersecting the second axial direction) is sometimes referred to as a “second radial direction.” Then, in the second radial direction, the center axis side along the second axis is referred to as a “second inner side,” and the side moving away from the center axis along the second axis is referred to as a “second outer side” in some cases.

As shown in FIG. 2, the damping force generation device 100 includes the main valve part 50 mainly generating the damping force in the hydraulic shock absorbing device 1 in the first exemplary embodiment, and the damping force adjusting part 60 adjusting the magnitude of the damping force generated in the damping force generation device 100. Furthermore, the damping force generation device 100 includes: a communication part 80 forming a parallel flow path with respect to the main valve part 50; a connection flow path part 90 forming a flow path of oil from the communication path L with respect to the main valve part 50 and the communication part 80; and an outer housing 100C housing various components constituting the damping force generation device 100.

### (Main Valve Part 50)

The main valve part 50 includes a main valve 51 generating the damping force by controlling the oil flow to narrow thereof, and a main valve seat 52 facing the main valve 51 and which the main valve 51 contacts.

As shown in FIG. 3, the main valve 51 has an opening part 51H at the second inner side and is a disc-shaped member that elastically deforms. As a material of the main valve 51, for example, metal such as iron can be used.

As shown in FIG. 4, the opening part 51H of the main valve 51 is penetrated by the communication part 80. In addition, the main valve 51 is sandwiched between the main valve seat 52 and a spacer member 684 (described later) on the second inner side. Then, the main valve 51 faces the second side of the main valve seat 52.

Movement of the position of the main valve 51, which is configured as described above, in the second radial direction is restricted by the communication part 80. In addition, movement of the second inner side of the main valve 51 in the second axial direction is restricted by the main valve seat 52 and the spacer member 684 (described later). On the other hand, the second outer side of the main valve 51 is movable in the second axis direction by deforming. Then, the main valve 51 generates the damping force by narrowing the oil flow in a main flow path 53, which will be described later, in the main valve seat 52.

Subsequently, the main valve seat 52 will be described.

As shown in FIG. 3, the main valve seat 52 is a cylindrical member having an opening part 52H at the second inner side. Then, the communication part 80 is inserted into a part of the opening part 52H of the main valve seat 52 (see FIG. 4).

The main valve seat 52 has a center seat part 520 around the opening part 52H. In addition, the main valve seat 52 includes an inner seat part 521, which is provided toward the second outer side than the center seat part 520, and an outer seat part 522, which is provided toward the second outer side than the inner seat part 521. Furthermore, the main valve seat 52 has the main flow path 53 penetrating in the second axial direction at the second outer side of the opening part 52H.

The center seat part 520 protrudes in an arc shape toward the main valve 51 side. A portion in the main valve 51 in the second inner side then faces the center seat part 520.

The inner seat part 521 is formed into an annular shape. The inner seat part 521 protrudes more toward the main valve 51 side than a flow path port 532. In addition, the protrusion height of the inner seat part 521 is substantially the same as that of the center seat part 520 and the outer seat part 522.

The outer seat part 522 is formed into an annular shape. The outer seat part 522 protrudes more toward the main valve 51 side than the flow path port 532.

The inner seat part 521 and the outer seat part 522 form a contact portion with the main valve 51.

Furthermore, the inner seat part 521 includes plural groove parts 521T formed along the second radial direction. The cross-sectional area of the flow path in each of the groove parts 521T is formed relatively small. In other words, the groove parts 521T constitute the so-called orifice flow path. Each groove 521T forms a flow path of the oil from the second inner side of the inner seat part 521 to the second outer side of the inner seat part 521, with the main valve 51 being in contact with the inner seat part 521.

The main flow path 53 constitutes a parallel flow path to a back pressure flow path 77 of a control seat 76 to be described later (see FIG. 4). In addition, plural main flow paths 53 are provided in the circumferential direction (see FIG. 3). Then, a flow path port 531 on the first side of each main flow path 53 communicates with the opening part 52H and faces the connection flow path part 90. In addition, a flow path port 532 on the second side of each main flow path 53 is located between the center seat part 520 and the inner seat part 521.

### (Damping Force Adjusting Part 60)

As shown in FIG. 2, the damping force adjusting part 60 includes: a forward/backward part 61 that allows a control valve 70, which will be described later, to move forward and backward with respect to the control seat 76; a cap part 67 that covers various components such as the main valve part 50; and a back pressure generation mechanism 68 that changes the deformability of the main valve 51 against the main valve seat 52. The damping force adjusting part 60 also includes: the control valve 70 that controls the oil flow at the communication part 80; the control seat 76 that is a valve seat facing the control valve 70 and which the control valve 70 contacts; and a narrowing member 83 that narrows the oil flow. In addition, the damping force adjusting part 60 includes: a regulation member 72 that regulates the movement of the control valve 70 toward the second side; and a biasing member 75 that applies a force in the direction against the thrust of the solenoid part 62 to the control valve 70. Moreover, the damping force adjustment part 60 includes: a first spacer member 73A that mediates between the biasing member 75 and the regulation member 72; a second spacer member 73B that exists between the regulation member 72 and the cap part 67; and the third spacer member 73C, which is mediated between the control seat 76 and the biasing member 75.

### ((Forward/Backward Part 61))

As shown in FIG. 2, the forward/backward part 61 includes: a solenoid part 62 that allows a pressing member 63, which will be described later, to move forward and backward using an electromagnet; the pressing member 63 that presses the control valve 70 against the control seat 76; and a coil spring 64 provided between the pressing member 63 and the control valve 70. The forward/backward part 61 also includes a solenoid case 60C that contains and supports the components constituting the forward/backward part 61.

The solenoid part 62 includes a plunger 65 that moves forward and backward along the second axial direction and pushes the plunger 65 toward the first side when the electromagnet is energized. The plunger 65 is pulled back toward the second side by the coil spring 64 when the solenoid part 62 is not energized.

The pressing member 63 includes: a cylinder-shaped cylindrical part 631; a bottom part 632 covering the opening part of the cylindrical part 631 on the first side; and a flange part 633 that is provided at the end part of the cylindrical part 631 on the second side and protrudes toward the second outer side over the entire circumference, as shown in FIG. 4.

The coil spring 64 is a compression coil spring that is in contact with the control valve 70 on the first side and is in contact with the pressing member 63 on the second side. The coil spring 64 then applies a force to each of the pressing member 63 and the control valve 70 in the direction in which the pressing member 63 and the control valve 70 are separated from each other. Note that, in place of the coil spring 64, other members, such as elastic rings, can be used as long as they perform the similar function.

### ((Cap Part 67))

As shown in FIG. 3, the cap part 67 includes a first opening part 67H1 formed on the first side and a second opening part 67H2 formed on the second side, and the approximate contour of the cap part 67 is cylindrical. In addition, the inner diameter of the first opening part 67H1 is formed larger than the inner diameter of the second opening part 67H2. Furthermore, plural inner diameter parts with different inner diameters are formed inside the cap part 67. Among the plural inner diameter parts, the inner diameter part provided on the first side is formed so that the inner diameter is larger than that of the inner diameter part provided on the second side. For example, the cap part 67 has a first inner diameter part 671 on the first side than the second opening part 67H2, a second inner diameter part 672 on the first side than the first inner diameter part 671, and a third inner diameter part 673 on the first side than the second inner diameter part 672.

As shown in FIG. 4, the cap part 67 contains the main valve part 50, the damping force adjusting part 60, and the communication part 80 therein. In more detail, the cap part 67 contains the main valve 51 of the main valve part 50 and the control valve 70. In addition, a part of the cap part 67, together with the back pressure generation mechanism 68 and the control seat 76, forms the back pressure chamber 68P, which applies an oil pressure (hereinafter sometimes referred to as “back pressure”) to the main valve 51 from the second side opposite to the main valve seat 52.

As shown in FIG. 2, the cap part 67 is pinched between the solenoid case 60C and the connection flow path part 90 to be fixed. The cap part 67 also forms a cap flow path 67R where oil flows between the cap part 67 and the solenoid case 60C. The cap flow path 67R communicates with the second opening part 67H2, and an in-housing flow path 111 which will be described later.

Furthermore, in the cap part 67, the plunger 65 is provided to penetrate through the second opening part 67H2. In addition, inside the cap part 67, the pressing member 63 moves forward and backward with respect to the second opening part 67H2.

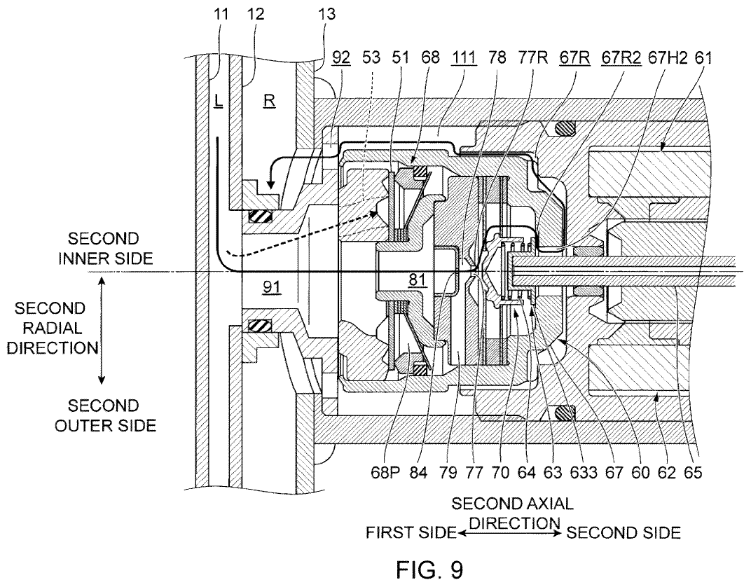

A groove part 675 is then formed on the edge of the first side of the second opening part 67H2 of the cap part 67. In the state in which the pressing member 63 moves to the second side and contacts the cap part 67, the groove part 675 forms a cap orifice flow path 67R2 (see FIG. 9) through which oil flows between the flange part 633 of the pressing member 63 and the cap part 67. The cap orifice flow path 67R2 communicates with the cap flow path 67R via the second opening part 67H2.

In the first exemplary embodiment, the cross section of the oil flow path in the groove part 675 is set to increase the pressure in the back pressure chamber 68P above a certain level when the solenoid part 62 is not energized. Furthermore, the cross section of the oil flow path in the groove part 675 is set to allow oil to flow to the groove part 675 to the extent that the main valve 51 opens the main flow path 53 to allow oil to flow when the solenoid part 62 is not energized.

The configuration that causes the oil flow between the cap part 67 and the pressing member 63 during the state described above in which the solenoid part 62 is not energized is not limited to the groove part 675. For example, a groove part provided in the pressing member 63 may provide the oil flow between the pressing member 63 and the cap part 67 in the state in which the pressing member 63 is in contact with the cap part 67. Alternatively, a configuration may be possible in which, in addition to the groove part 675 being formed in the cap part 67, a groove part is provided in the pressing member 63. Furthermore, the configuration that causes the oil flow between the pressing member 63 and the cap part 67 in the state in which the pressing member 63 is in contact with the cap part 67 is not limited to the groove part and may be a through hole.

### ((Back Pressure Generation Mechanism 68))

As shown in FIG. 3, the back pressure generation mechanism 68 includes a partition member 681 provided on the opposite side of the main valve seat 52 with respect to the main valve 51, namely, the second side, and a seal member 682 that seals between the cap part 67 and the partition member 681. Further, the back pressure generation mechanism 68 includes a return spring 683 that provides a force to the partition member 681 that presses the partition member 681 against the main valve 51, and the spacer member 684 that mediates between the return spring 683 and the main valve 51.

The approximate contour of the partition member 681 is formed into a substantially annular shape. The partition member 681 is movable in the second axial direction. For example, the partition member 681 moves toward the second side when the main valve 51 deforms toward the second side. The partition member 681 also moves toward the first side when the main valve 51 deforms toward the first side.

Further, the partition member 681 includes a main valve contact part 681V that contacts the main valve 51, and a seal contact part 681S on which a seal member 682 is to be provided.

The main valve contact part 681V is provided on the first side in the partition member 681. The main valve contact part 681V is formed so that the width thereof gradually decreases from the second side to the first side. The main valve contact part 681V makes an annular contact with the main valve 51. The partition member 681 constitutes one of the components that form the back pressure chamber 68P.

Here, the back pressure chamber 68P is a chamber which, when oil enters therein, applies a hydraulic pressure corresponding to the entered oil to the main valve 51. The back pressure chamber 68P then acts to provide a force on the main valve 51 that presses the main valve 51 against the main valve seat 52.

As shown in FIG. 3, the seal member 682 is formed into an annular shape. In addition, resin materials that deform elastically, such as engineering plastics and rubber, can be used for the seal member 682.

Then, as shown in FIG. 4, the seal member 682 seals between the partition member 681 and the third inner diameter part 673 of the cap part 67. In more detail, the outer circumferential surface 682G of the seal member 682 contacts the inner circumference of the third inner diameter part 673 of the cap part 67. In addition, the end surface 682T on the first side of the seal member 682 contacts the partition member 681. This allows the seal member 682 to suppress oil in the back pressure chamber 68P flowing out of the back pressure chamber 68P through the gap between the partition member 681 and the cap part 67.

As shown in FIG. 3, the return spring 683 includes an annular part 683R formed annularly and plural arm parts 683A protruding from the annular part 683R toward the second outer side. In addition, as a material of the return spring 683, elastic members such as metal can be used.

As shown in FIG. 4, the communication part 80 of the return spring 683 penetrates through the annular part 683R, and the annular part 683R is sandwiched in the second axis direction by plural spacer members 684. In addition, the arm parts 683A of the return spring 683 contact the seal member 682.

In the return spring 683, the position where the annular part 683R is fixed by the spacer member 684 and the position where the arm part 683A contacts the seal member 682 are different in the second axial direction. The arm part 683A then has a shape that is inclined to the second axial direction. Further, the arm part 683A is in contact with a corner portion on the second side and the second inner side of the seal member 682. This allows the arm part 683A to provide a spring force of the component along the second axial direction and a spring force of the component along the second radial direction to the seal member 682.

Further, the arm part 683A of the return spring 683 of the first exemplary embodiment is also in contact with the partition member 681. The return spring 683 then provides the spring force of the component along the second axial direction and the spring force of the component along the second radial direction to the partition member 681.

### ((Control Valve 70))

The control valve 70 includes a cylinder-shaped cylindrical part 701, a cone-shaped conical part 702 covering the opening part on the first side in the cylindrical part 701 and protruding toward the first side. The control valve 70 also includes a protruding part 71 at the end part on the first side of the cylindrical part 701, which protrudes toward the second outer side over the entire circumference. In addition, the control valve 70 includes a flat surface 703 perpendicular to the second axial direction, which is located at an end portion on the second side in the conical part 702 and on the second inner side. The control valve 70 also includes a convex part 706 at the center portion in the second axial direction of the conical part 702, which protrudes toward the second outer side. At the convex part 706, a flat surface 707 perpendicular to the second axial direction is formed.

The size of the outer diameter of the cylindrical part 701 is larger than or equal to the size of the outer diameter of the flange part 633 of the pressing member 63, and the size of the inner diameter of the cylindrical part 701 is smaller than the size of the outer diameter of the flange part 633. This causes the end surface on the second side of the cylindrical part 701 to be in contact with the flange part 633 of the pressing member 63.

In addition, the size of the inner diameter of the cylindrical part 701 is larger than the size of the outer diameter of the cylindrical part 631 of the pressing member 63. This causes, in the state where the end surface on the second side of the cylindrical part 701 is in contact with the flange part 633 of the pressing member 63, the cylindrical part 631 and the bottom part 632 of the pressing member 63 to be contained in the second inner side of the control valve 70. The coil spring 64 (an example of an elastic member) is then disposed in space 704 (an example of spring space) formed between the cylindrical part 701 of the control valve 70 and the cylindrical part 631 of the pressing member 63. The end portion on the first side of the coil spring 64 is supported by the flat surface 703 of the control valve 70 and the end portion on the second side of the coil spring 64 is supported by the flange part 633 of the pressing member 63. In this way, the coil spring 64 is a member acting at both ends and has no fixed end. Therefore, the thrust efficiency is optimal because all of the thrust of the solenoid part 62 applied to the coil spring 64 is used to deform the coil spring 64 itself.

### ((Regulation Member 72))

As shown in FIG. 3, the regulation member 72 includes an annular part 721 formed annularly and plural arm parts 722 protruding from the annular part 721 toward the second inner side. The four arm parts 722 are provided at regular intervals in the circumferential direction of the annular part 721. The size of the arm part 722 in the circumferential direction gradually decreases from the second outer side toward the second inner side. The diameter of a virtual circle formed by the tip end of the second inner side of the plural arm parts 722 is larger than the diameter of the outer circumference of the cylindrical part 701 of the control valve 70 and smaller than the diameter of the outer circumference of the protruding part 71.

### ((First Spacer Member 73A, Second Spacer Member 73B, and Third Spacer Member 73C))

The first spacer member 73A, the second spacer member 73B, and the third spacer member 73C are annular members. The outer diameter of the first spacer member 73A, the second spacer member 73B, and the third spacer member 73C is larger than the inner diameter of the first inner diameter part 671 of the cap part 67 and smaller than the inner diameter of the second inner diameter part 672. In addition, the inner diameter of the first spacer member 73A, the second spacer member 73B, and the third spacer member 73C is larger than the inner diameter of the first inner diameter part 671 of the cap part 67 and smaller than the inner diameter of the second inner diameter part 672.

The first spacer member 73A and the second spacer member 73B are disposed between the end face on the first side in the first inner diameter part 671 of the cap part 67 and the biasing member 75 and determine the position of the regulation member 72 in the second axial direction. More specifically, the regulation member 72 is located on the second side than the protruding part 71 of the control valve 70 and regulates the movement of the control valve 70 to the second side.

The position of the regulated member 72 in the second axis direction can be adjusted by adjusting the size of the first spacer member 73A and the second spacer member 73B in the second axis direction (hereinafter referred to as “thickness” in some cases). For example, in the case where the position of the regulation member 72 in the second axis direction is to be set to the first side than that in FIG. 4, it is desirable to make the thickness of the first spacer member 73A thinner than that shown in FIG. 4, and to make the thickness of the second spacer member 73B thicker than that shown in FIG. 4. On the other hand, in the case where the position of the regulation member 72 in the second axis direction is to be set to the second side than that in FIG. 4, it is desirable to make the thickness of the first spacer member 73A thicker than that shown in FIG. 4, and to make the thickness of the second spacer member 73B thinner than that shown in FIG. 4.

The third spacer member 73C is disposed between the biasing member 75 and the control seat 76 to determine the position of the biasing member 75 in the second axial direction. Then, the position of the biasing member 75 in the second axis direction can be adjusted by adjusting the size of the third spacer member 73C in the second axis direction (hereinafter referred to as “thickness” in some cases). For example, in the case where the position of the biasing member 75 in the second axis direction is to be set to the first side than that in FIG. 4, it is desirable to make the thickness of the third spacer member 73C thinner than that shown in FIG. 4, and to make the thickness of the first spacer member 73A thicker than that shown in FIG. 4. On the other hand, in the case where the position of the biasing member 75 in the second axis direction is to be set to the second side than that in FIG. 4, it is desirable to make the thickness of the third spacer member 73C thicker than that shown in FIG. 4, and to make the thickness of the first spacer member 73A thinner than that shown in FIG. 4.

### ((Biasing Member 75))

The biasing member 75 is an annular-shaped plate spring that applies the thrust of the solenoid part 62 and force in the direction against the spring force of the coil spring 64 to the control valve 70, and the spring constant thereof is set higher than that of the coil spring 64. The biasing member 75 includes an annular part 751 formed annularly and functioning as a fixed end, and plural arm parts 752 protruding from the annular part 751 toward the second inner side and functioning as an acting end. Note that the shape of the biasing member 75 is not limited to the above, and the shape is not particularly limited if the biasing member 75 has the fixed end and the acting end acting on the control valve 70. For example, three arm parts 752 are provided at regular intervals in the circumferential direction of the annular part 751. However, the number of the arm parts 752 is not limited to three and may be two or less or four or more. In addition, the shapes of the plural arm parts 752 may all be the same or different from one another. For example, the plural arm parts 752 may have different sizes in the circumferential direction. Note that the biasing member 75 does not need to be a plate spring but may be an elastic member such as a coil spring mediated between the control valve 70 and the control seat 76.

### ((Control Seat 76))

The control seat 76 includes: an outer seat part 761 that holds, together with the cap part 67, the regulation member 72, the biasing member 75, the first spacer member 73A, the second spacer member 73B, and the third spacer member 73C; and a concave part 762 that is recessed from a surface on the second side of the outer seat part 761, which is provided to the second inner side. In a portion at the second inner side of the concave part 762, the back pressure flow path 77 is formed, which is a through hole in the second axial direction and forms the oil flow path for adjusting the oil pressure in the back pressure chamber 68P. The control seat 76 has a round 77R around the back pressure flow path 77, which protrudes toward the second side more than the bottom part of the concave part 762.

Furthermore, the control seat 76 includes a communication chamber 78 that is provided to the first side than the back pressure flow path 77 and communicates with the back pressure flow path 77. Then, around the communication chamber 78 in the control seat 76, plural back pressure communication paths 79 are formed in the circumferential direction, which are through holes penetrating in the second radial direction to communicate the communication chamber 78 and the back pressure chamber 68P.

The control seat 76 configured as described above, together with the control valve 70, constitutes a valve 700 that is provided on a discharge flow path, which will be described later, and varies the area of the discharge flow path.

### ((Narrowing Member 83))

The narrowing member 83 is fitted to the first side than the communication chamber 78 of the control seat 76 and includes a cylinder-shaped cylindrical part 831, and a closing part 832 closing the opening part on the second side in the cylindrical part 831. In the closing part 832, a back pressure orifice flow path 84 is formed to connect an inlet flow path 81, which will be described later, and the communication chamber 78. The back pressure orifice flow path 84 is formed so that the cross section of the oil flow path is smaller than that of the back pressure communication path 79 and the back pressure flow path 77. The back pressure orifice flow path 84 makes it difficult for the oil in the back pressure chamber 68P to return to the inlet flow path 81

### (Communication Part 80)

As shown in FIG. 3, the communication part 80 in the first exemplary embodiment includes the inlet flow path 81 for which the oil enters from the communication path L, and a connection part 89 for connecting to the control seat 76.

The inner diameter of the connection part 89 is substantially equal to the outer diameter on the first side of the control seat 76. The end portion on the first side of the control seat 76 is then inserted into the connection part 89. Note that the communication part 80 may be configured to be inserted into the interior of the control seat 76.

### (Connection Flow Path Part 90)

As shown in FIG. 2, the connection flow path part 90 includes: an inner flow path 91 provided on the second inner side; and outer flow paths 92 provided on the second outer side.

The inner flow path 91 communicates with the outer cylindrical body opening part 12H on the first side and communicates with the inlet flow path 81 of the communication part 80 and the main flow path 53 of the main valve seat 52 on the second side.

The plural outer flow paths 92 are provided in the circumferential direction. Then, the outer flow paths 92 communicate with the case opening part 13H on the first side and communicate with the in-housing flow path 111 on the second side.

### (Outer Housing 100C)

As shown in FIG. 2, the outer housing 100C is substantially a cylindrical member. The outer housing 100C is fixed to the damper case 13, for example by welding, on the first side. In addition, the outer housing 100C forms the in-housing flow path 111, which is the oil flow path in the outer housing 100C, on the second outer side of the main valve part 50 and the damping force adjusting part 60.

The in-housing flow path 111 is configured to allow oil flowing out of the second opening part 67H2 of the cap part 67 and oil flowing out of the main flow path 53 of the main valve seat 52 upon opening of the main valve 51 to flow in.

### (Adjusting Operation of Damping Force Adjusting Part 60)

Next, adjusting operations in the damping force adjusting part 60 will be described. As shown in FIG. 4, the control valve 70 is pressed against the control seat 76 by pressing the pressing member 63 toward the first side. The pressing force of the pressing member 63, in other words, the thrust of the solenoid part 62, varies according to the amount of current flowing to the solenoid part 62 (see FIG. 2).

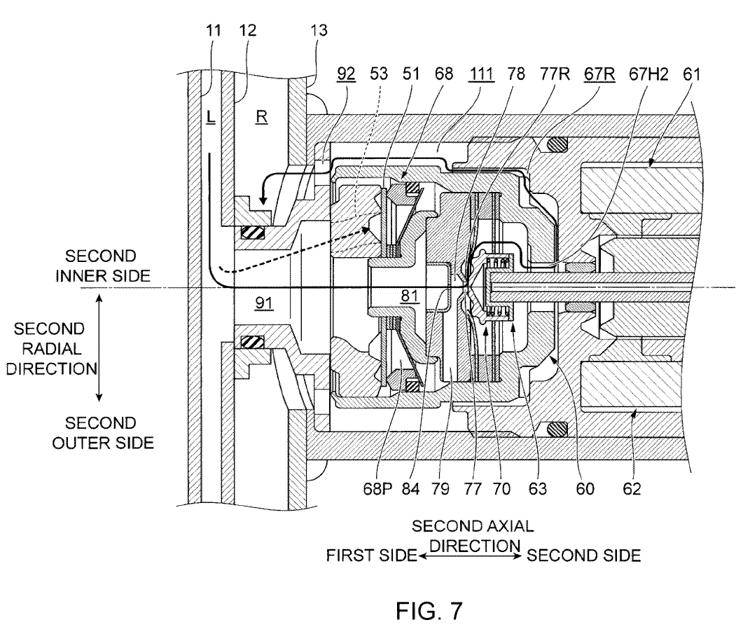

For example, in the damping force adjustment part 60, the state in which the pressing force of the pressing member 63 is maximized is formed. At this time, the control valve 70 is pressed most strongly against the back pressure flow path 77 of the control seat 76, which causes the back pressure flow path 77 to be closed (see FIG. 7).

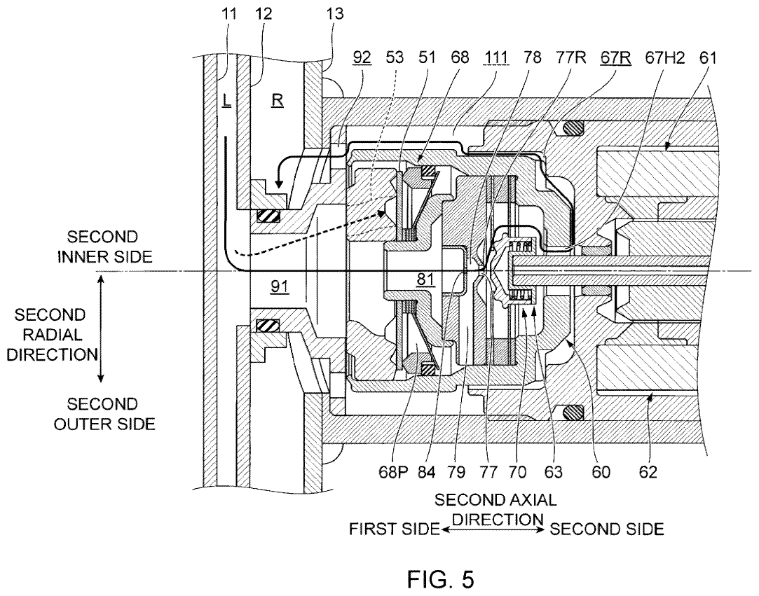

In addition, for example, in the damping force adjustment part 60, the state in which the pressing force of the pressing member 63 is minimized is formed. At this time, in the damping force adjusting part 60, the control valve 70 is away from the back pressure flow path 77, which opens the back pressure flow path 77 (see FIG. 5).

Further, for example, in the damping force adjustment part 60, the state in which the pressing force of the pressing member 63 is between the minimum and maximum is formed. In this state, in the damping force adjusting part 60, the control valve 70 is further from the back pressure flow path 77 than in the maximum pressing force state and closer to the back pressure flow path 77 than in the minimum pressing force state.

### Operation of Hydraulic Shock Absorbing Device 1

First, the operations of the hydraulic shock absorbing device 1 during the extension stroke will be described.

During the extension stroke, the rod 20 moves to the other side with respect to the cylinder 11. At this time, the piston valve 32 remains closing the piston oil ports 311. In addition, the movement of the piston part 30 to the other side reduces the volume of the second oil chamber Y2. Then, the oil in the second oil chamber Y2 flows from the communicating hole 11H to the communication path L.

Furthermore, the oil flows through the communication path L and the outer cylindrical body opening part 12H, and flows into the damping force generation device 100. Then, in the damping force generation device 100, first, the oil flows into the inner flow path 91 of the connection flow path part 90. After that, in the damping force generation device 100, the damping force is generated at the main valve 51 or the control valve 70. Note that the flow of oil at this time will be described in detail later.

Thereafter, the oil that has flowed through the main valve 51 or the control valve 70 then flows into the in-housing flow path 111. Furthermore, the oil flows through the outer flow path 92 of the connection flow path part 90, and flows into the reservoir chamber R from the case opening part 13H.

In addition, the pressure in the first oil chamber Y1 becomes lower relative to the reservoir chamber R. Therefore, the oil in the reservoir chamber R flows into the first oil chamber Y1 through the bottom part 40.

Next, the operations of the hydraulic shock absorbing device 1 during the compression stroke will be described.

During the compression stroke, the rod 20 moves to the one side relative to the cylinder 11. In the piston part 30, the differential pressure between the first oil chamber Y1 and the second oil chamber Y2 opens the piston valve 32 that closes the piston oil ports 311. The oil in the first oil chamber Y1 then flows into the second oil chamber Y2 through the piston oil ports 311. Here, the rod 20 is disposed in the second oil chamber Y2. Therefore, the oil flowing from the first oil chamber Y1 to the second oil chamber Y2 becomes excessive by the volume of the rod 20. Accordingly, the oil of the amount equivalent to the volume of the rod 20 flows from the communicating hole 11H to the communication path L.

Furthermore, the oil flows through the communication path L and the outer cylindrical body opening part 12H, and flows into the damping force generation device 100. Note that the flow of the oil in the damping force generation device 100 is the same as the flow of the oil during the extension stroke described above. In other words, in the hydraulic shock absorbing device 1 of the first exemplary embodiment, the direction of the oil flow in the damping force generation device 100 is the same in both the compression stroke and the extension stroke.

As described above, in the hydraulic shock absorbing device 1, the damping force is generated in the damping force generation device 100 in both the compression stroke and the extension stroke.

Next, the oil flow in the damping force generation device 100 will be described in detail.

### (Normal State)

The oil flow during the normal state where the solenoid part 62 is energized and the pressing force of the pressing member 63 is applied will be described.

### ((At Low Speed))

FIG. 5 is a diagram showing an example of the oil flow when the moving speed of the piston part 30 (see FIG. 1) is low in the state where the pressing force of the pressing member 63 is minimized.

As shown in FIG. 5, in the case where the moving speed of the piston part 30 is low, the oil flowing through the inner flow path 91 flows into the inlet flow path 81 and the main flow path 53. Here, there is no oil flow to open the main valve 51 in the main flow path 53 due to the low moving speed of the piston part 30.

On the other hand, the oil that has flowed into the inlet flow path 81 flows in the order of the back pressure orifice flow path 84, the communication chamber 78, the back pressure flow path 77, the second opening part 67H2, and the cap flow path 67R, as indicated by the arrows in FIG. 5. The oil then flows from the in-housing flow path 111 into the reservoir chamber R.

As described above, in the case where the moving speed of the piston part 30 is low, the damping force is generated by the oil flow being narrowed by the gap between the round 77R and the control valve 70.

### ((At High Speed))

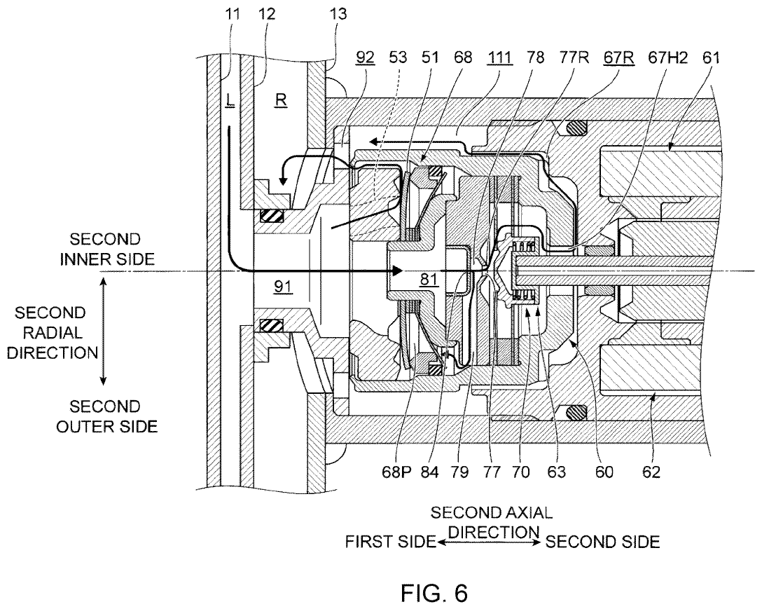

FIG. 6 is a diagram showing an example of the oil flow when the moving speed of the piston part 30 (see FIG. 1) is high in the state where the pressing force of the pressing member 63 is minimized.

As shown in FIG. 6, in the case where the moving speed of the piston part 30 is high, the oil flowing through the inner flow path 91 flows into the inlet flow path 81 and the main flow path 53. The oil that has flowed into the main flow path 53 flows into the reservoir chamber R by opening the main valve 51.

Note that, even in the case where the moving speed is high, similarly to the case of the low speed, the oil that has flowed into the inlet flow path 81 flows to the in-housing flow path 111 while the flow rate is narrowed by the gap between the round 77R and the control valve 70 to generate the differential pressure, and then flows into the reservoir chamber R.

As described above, in the case where the moving speed of the piston part 30 is high, the damping force is mainly generated by the oil flow in the main flow path 53 of the main valve seat 52.

In addition, the oil that has flowed into the inlet flow path 81 transmits pressure to the back pressure chamber 68P through the back pressure orifice flow path 84 and the back pressure communication path 79. However, the back pressure flow path 77, which communicates with the back pressure chamber 68P, is in an open condition by the control valve 70. Therefore, the pressure in the back pressure chamber 68P is low as compared to the case in which the control valve 70 is pressed against the back pressure flow path 77. It is then easier for the main valve 51, which is in contact with the back pressure generation mechanism 68, to open the main flow path 53. Therefore, in the state where the pressing force of the pressing member 63 is minimized, the damping force generated by the oil flow in the main flow path 53 that opens the main valve 51 is smaller than in the state where the pressing force of the pressing member 63 is maximized.

FIG. 7 is a diagram showing an example of the oil flow when a moving speed of the piston part 30 (see FIG. 1) is low in the state where the pressing force of the pressing member 63 is maximized.

### ((At Low Speed))

As shown in FIG. 7, in the case where the moving speed of the piston part 30 is low, the oil flowing through the inner flow path 91 flows into the inlet flow path 81 and the main flow path 53. Here, no oil flow is generated to open the main valve 51 and flow through the main flow path 53 due to the low moving speed of the piston part 30.

On the other hand, the oil that has flowed into the inlet flow path 81 flows to the back pressure orifice flow path 84 and the communication chamber 78, as indicated by the arrows in FIG. 7. The oil then flows through the back pressure flow path 77 while opening the control valve 70. In addition, the oil flows through in the order of the second opening part 67H2 and the cap flow path 67R. The oil then flows from the in-housing flow path 111 into the reservoir chamber R.

As described above, in the case where the moving speed of the piston part 30 is low, the damping force is generated by the oil that flows through the back pressure flow path 77 while opening the control valve 70. The damping force while flowing through the back pressure flow path 77 is large as compared to the case where the control valve 70 is away from the back pressure flow path 77.

### ((At High Speed))

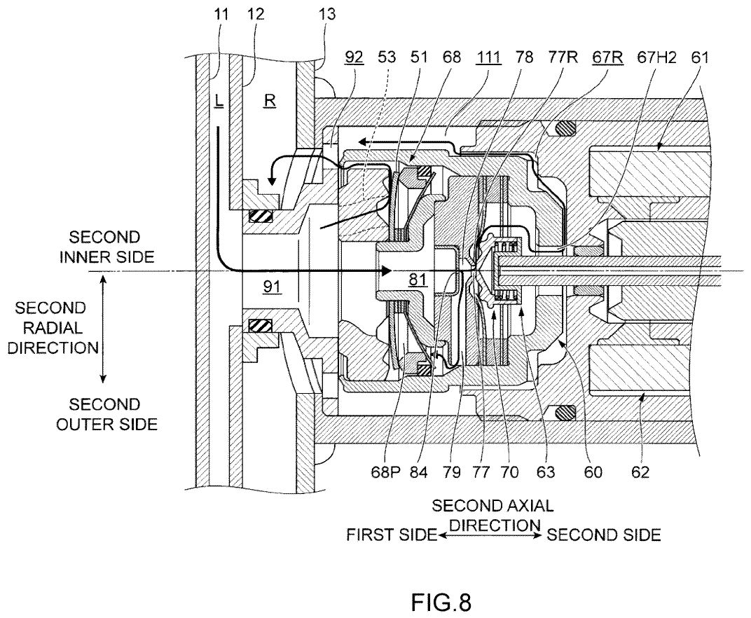

FIG. 8 is a diagram showing an example of the oil flow when a moving speed of the piston part 30 (see FIG. 1) is high in the state where the pressing force of the pressing member 63 is maximized.

As shown in FIG. 8, in the case where the moving speed of the piston part 30 is high, the oil flowing through the inner flow path 91 flows into the inlet flow path 81 and the main flow path 53. The oil that has flowed into the main flow path 53 flows into the reservoir chamber R by opening the main valve 51.

Note that, even in the case where the moving speed is high, similarly to the case of the minimum pressing force of the pressing member 63, the oil that has flowed into the inlet flow path 81 flows to the in-housing flow path 111 while the flow rate is narrowed by the gap between the round 77R and the control valve 70 to generate the differential pressure, and then flows into the reservoir chamber R.

As described above, in the case where the moving speed of the piston part 30 is high, the damping force is mainly generated by the oil flow in the main flow path 53 of the main valve seat 52.

In addition, the oil that has flowed into the inlet flow path 81 transmits pressure to the back pressure chamber 68P through the back pressure orifice flow path 84 and the back pressure communication path 79. The back pressure flow path 77, which communicates with the back pressure chamber 68P, is in the state pressed by the control valve 70. Therefore, the pressure in the back pressure chamber 68P is high as compared to the case in which the back pressure flow path 77 is opened. It is then more difficult for the main valve 51, which is in contact with the back pressure generation mechanism 68, to open the main flow path 53. Therefore, in the state where the pressing force of the pressing member 63 is maximized, the damping force generated by the oil flow in the main flow path 53 that opens the main valve 51 is larger than in the state where the pressing force of the pressing member 63 is minimized.

As described above, the hydraulic shock absorbing device 1 adjusts both the damping force at low speed and the damping force at high speed by operating the pressing member 63. In other words, the hydraulic shock absorbing device 1 adjusts the flow path area of the back pressure flow path 77, which is the flow path of the oil at low speed, and the flow path area of the back pressure flow path 77, which adjusts the pressure in the back pressure chamber 68P related to the flow path area at high speed, by changing the pressing force of the control valve 70 against the control seat 76 by the pressing member 63.

In the above operation example, two patterns, the state in which the pressing force of the pressing member 63 is the minimum and the state in which the pressing force is the maximum, have been described, but are not limited to the aforementioned two patterns. The amount of current for the solenoid part 62, in other words, the pressing force of the pressing member 63 can be set arbitrarily within an adjustable range according to the thrust of the solenoid part 62. With this setting, then, the damping force adjusting part 60 can adjust the damping force at low speed and the damping force at high speed in plural phases.

### (Abnormal State)

Next, the oil flow during the abnormal state where the solenoid part 62 is not energized and the pressing force of the pressing member 63 is not applied will be described. As the case in which the solenoid part 62 becomes de-energized, a case can be exemplified, in which the current supply to the coil of the solenoid part 62 stops due to a wire break, etc.

FIG. 9 is a diagram showing an example of the oil flow when the moving speed of the piston part 30 (see FIG. 1) is low in the state where a solenoid part 62 is not energized.

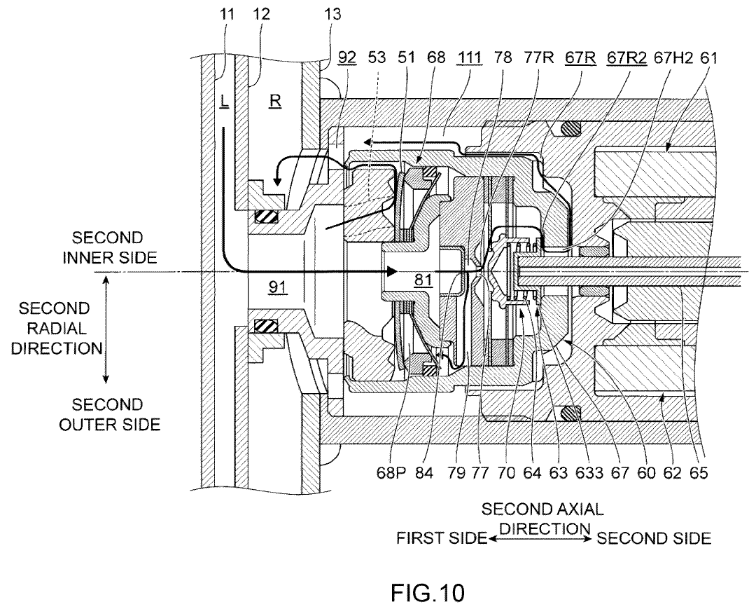

FIG. 10 is a diagram showing an example of the oil flow when the moving speed of the piston part 30 is high in the state where the solenoid part 62 is not energized.

As shown in FIGS. 9 and 10, when the solenoid part 62 is not energized, the plunger 65 is pushed back toward the second side by the coil spring 64. With this, the pressing member 63, which is fixed to the plunger 65, is pressed against the cap part 67.

### ((At Low Speed))

As shown in FIG. 9, in the case where the moving speed of the piston part 30 is low, the oil that has flowed into the inlet flow path 81 flows in the order of the back pressure orifice flow path 84, the communication chamber 78, the back pressure flow path 77, the cap orifice flow path 67R2, the second opening part 67H2, and the cap flow path 67R. The oil then flows from the in-housing flow path 111 into the reservoir chamber R.

Then, in the case where the moving speed of the piston part 30 is low, the damping force is generated by the oil flow in the cap orifice flow path 67R2 formed between the flange part 633 of the pressing member 63 and the cap part 67.

### ((At High Speed))

As shown in FIG. 10, in the case where the moving speed of the piston part 30 is high, the oil that has flowed through the inner flow path 91 flows into the inlet flow path 81 and the main flow path 53. The oil that has flowed into the main flow path 53 flows into the reservoir chamber R by opening the main valve 51.

Note that, even in the case where the moving speed is high, similarly to the case of the low speed, the oil that has flowed into the inlet flow path 81 flows to the in-housing flow path 111 while the flow rate is narrowed by the cap orifice flow path 67R2 to generate the differential pressure, and further flows into the reservoir chamber R.

As described above, in the case where the moving speed of the piston part 30 is high, the damping force is mainly generated by the oil flow in the main flow path 53 of the main valve seat 52.

Here, the oil that has flowed into the inlet flow path 81 transmits pressure to the back pressure chamber 68P through the back pressure orifice flow path 84 and the back pressure communication path 79. The back pressure chamber 68P communicates with the in-housing flow path 111 via the back pressure flow path 77. The oil flow between the back pressure chamber 68P and the in-housing flow path 111 has to pass through the cap orifice flow path 67R2. The narrowing of the oil flow by the cap orifice flow path 67R2 then suppresses the oil flow out of the back pressure chamber 68P and maintains the pressure in the back pressure chamber 68P at a level higher than that in the minimum pressing force state of the pressing member 63 shown in FIG. 6. It is then relatively more difficult for the main valve 51, which is in contact with the back pressure generation mechanism 68, to open the main flow path 53. Therefore, in the state where the solenoid part 62 is not energized, the damping force generated by the oil flow in the main flow path 53 that opens the main valve 51 is relatively large.

As described above, in the hydraulic shock absorbing device 1 of the first exemplary embodiment, both the damping force at low speed and the damping force at high speed are set relatively high even in the abnormal state in which the solenoid part 62 is not energized.

### (Difference Between Normal State and Abnormal State)

When the resultant of the force of the oil passing through the back pressure flow path 77, which moves the control valve 70 toward the second side, and the force of the coil spring 64 exceeds the pressing force of the pressing member 63, the control valve 70 moves toward the second side even though the thrust of the solenoid part 62 is generated. In particular, when the thrust of the solenoid part 62 is relatively small, such as the state in which the pressing force of the pressing member 63 is the minimum shown in FIGS. 5 and 6, the control valve 70 temporarily moves toward the second side if the pressure of the oil passing through the back pressure flow path 77 increases.

In the damping force generation device 100, even if the control valve 70 moved toward the second side, the regulation member 72 suppresses the movement of the control valve 70 toward the second side. In other words, the protruding part 71 comes into contact with the regulation member 72, which causes the control valve 70 to receive a force from the regulation member 72 in the direction toward the first side, thereby suppressing the movement toward the second side.

In addition, the cylindrical part 631 and the bottom part 632 of the pressing member 63 are disposed at the second inner side of the cylindrical part 701 and the conical part 702 of the control valve 70, and the diameter of the outer circumferential portion of the flange part 633 of the pressing member 63 is less than or equal to the outer diameter of the cylindrical part 701 of the control valve 70, and therefore, the pressure member 63 is less likely to receive the force of the oil passing through the back pressure flow path 77 and flowing toward the second opening part 67H2. As a result, the movement of the pressing member 63 toward the second side is also suppressed, which makes it easy for the pressing member 63 to remain stable in the operating position in the normal state and makes it difficult for the pressing member 63 to be pressed against the cap part 67, which is the operating position in the abnormal state.

Thus, in the damping force generation device 100 of the exemplary embodiment, in the normal state, even if the resultant of the force of the oil moving the control valve 70 toward the second side and the force of the coil spring 64 exceeds the thrust of the solenoid part 62, it is difficult for the pressing member 63 to be pressed against the cap part 67. In other words, in the damping force generation device 100, unlike the abnormal state operation, it is difficult for the pressing member 63 to be pressed against the cap part 67 in the normal state. Thus, according to the damping force generation device 100, it is possible to prevent the operation for the abnormal state even though the mechanism can operate normally, and also to enable the operation for the abnormal state in case of occurrence of abnormality as the mechanism. In addition, even if the flow path cross-sectional area of the cap orifice flow path 67R2 is changed to adjust the damping force generated during the abnormal state, this change can be prevented from affecting the damping force during the normal state.

As described above, the damping force generation device 100 includes: the main valve 51 (an example of a main valve) that restricts the flow of oil (an example of a fluid) and generates the damping force; the back pressure chamber 68P that applies pressure to the main valve 51 in the closing direction; and the flow path (hereinafter referred to as “discharge flow path” in some cases) that allows the oil to flow from the back pressure chamber 68P. The discharge flow path includes the back pressure communication path 79, the communication chamber 78, the back pressure flow path 77, the second opening part 67H2, the cap flow path 67R, and the in-housing flow path 111. In addition, the damping force generation device 100 includes the valve 700 that is provided on the discharge flow path, and has the control valve 70 (an example of a valve body) which varies the area of the discharge flow path, and a control seat 76 (an example of a valve seat) on which the control valve 70 can be seated. In addition, the damping force generation device 100 includes the pressing member 63 that can contact the side opposite to the side facing the control seat 76 of the control valve 70 and can apply the pressing force in the direction that the control valve 70 is pressed against the control seat 76. The damping force generation device 100 also includes the solenoid part 62 as an example of an actuator part capable of generating thrust between a first position and a second position according to the current to be supplied. The first position can be exemplified as the position shown in FIG. 7, where the pressing member 63 is closest to the control seat 76. Moreover, the second position can be exemplified as the position shown in FIG. 9, where the pressing member 63 is farthest from the control seat 76. Assuming that the damping force generation device 100 does not include the regulation member 72, in the case where the pressure of the oil passing through the back pressure flow path 77 is high, even if the pressing member 63 is in the second position shown in FIG. 9, the control valve 70 is in a state where the end face on the second side of the cylindrical part 701 is in contact with the flange part 633 of the pressing member 63. In this state, in other words, when the pressing member 63 is in the second position shown in FIG. 9, the position of the control valve 70, where the end face on the second side of the cylindrical part 701 is in contact with the flange part 633 of the pressing member 63, is virtually referred to as the second position of the control valve 70. The solenoid part 62 applies thrust to the pressing member 63 and presses thereof from the second position toward the first position. In addition, the damping force generation device 100 includes the regulation member 72 that regulates the movement of the control valve 70 so that the pressing member 63 does not reach the second position even if the control valve 70 moves in the direction that the pressing member 63 moves toward the second position due to the pressure of the oil passing through the discharge flow path. In other words, the damping force generation device 100 includes a housing that is formed in a tubular shape to accommodate the pressing member 63 and the control valve 70, and protrusions are formed on the inner circumferential surface. In other words, an object constituted by the cap part 67, the first spacer member 73A and the second spacer member 73B (an example of a pair of spacers), etc. is formed into a tubular shape that accommodates the pressing member 63 and the control valve 70, as well as the regulation member 72 protrudes toward the second inner side than the inner circumferential surface of the first spacer member 73A and the second spacer member 73B. Then, the regulation member 72 and the protruding part 71 of the control valve 70 function as an example of a regulation part that regulates the movement of the control valve 70 toward the second position in a third position between the first position and the second position. The third position can be exemplified as the position shown in FIG. 9, where the protruding part 71 of the control valve 70 hits against the regulation member 72.

According to the damping force generation device 100, even if the pressure of the oil passing through the back pressure flow path 77 is high, and the control valve 70 moves toward the second side to move the pressing member 63 toward the second side, the movement of the control valve 70 is regulated by the regulation member 72, so that the pressing member 63 does not reach the position farthest from the control seat 76. The pressing member 63 reaches the position farthest from the control seat 76 when the current supplied to the solenoid part 62 is 0, in other words, when the solenoid part 62 is not energized and the thrust of the solenoid part 62 becomes zero, which is the abnormal state. Therefore, according to the damping force generation device 100, in the normal state in which the mechanism can operate normally, even if the pressure of the oil passing through the back pressure flow path 77 is high, the abnormal state operations are suppressed.

The damping force generation device 100 further includes the coil spring 64 (an example of a moving member) that generates force on the pressing member 63 in the direction away from the control valve 70 and can move the pressing member 63 to the second position in the case where the movement of the control valve 70 is regulated by the regulation member 72. Thus, in the abnormal state where the thrust of the solenoid part 62 becomes zero, it is possible to press the pressing member 63 against the cap part 67 with high accuracy. Therefore, when an abnormality actually occurs in the mechanism, it is possible to perform the operations for the abnormal state with high accuracy.

The coil spring 64 is an example of the elastic member disposed between the control valve 70 and the pressing member 63. Therefore, it is possible to make the damping force adjusting part 60 a simplified configuration.

The pressing member 63 is fixed to the plunger 65 (an example of a driving member) of the solenoid part 62. Therefore, it is possible to adjust the damping force with high accuracy according to the current supplied to the solenoid part 62, such that, for example, it is possible to press the pressing member 63 against the cap part 67 with high accuracy in the abnormal state where the thrust of the solenoid part 62 becomes zero.

The pressing member 63 includes: the cylindrical part 631 (an example of a tubular part); the bottom part 632 covering the opening part of the cylindrical part 631 on the control seat 76 side; and the flange part 633 (an example of an applying part) that protrudes from the outer circumferential surface of the cylindrical part 631 toward the second outer side (an example of an outside) and applies the pressing force to the control valve 70. The control valve 70 then accommodates the cylindrical part 631 and the bottom part 632 of the pressing member 63. Therefore, the pressing member 63 is less likely to receive the pressure of the oil passing through the back pressure flow path 77. As a result, in the normal state, even if the pressure of the oil passing through the back pressure flow path 77 is high, since the movement of the pressing member 63 toward the second side is suppressed, it is easy for the pressing member 63 to remain stable in the operating position, and operations for the abnormal state are prevented from being performed.

In addition, the damping force adjusting part 60 as an example of a damping force adjusting device includes: the control valve 70 that is provided on the flow path, through which a fluid flows, and varies the area of the flow path; and a case member that accommodates the control valve 70 and has the control seat 76 (an example of the valve seat) on which the back pressure flow path 77 (an example of a through hole) which can be closed by the control valve 70 is formed. The case member is constituted by the control seat 76, the cap part 67, the first spacer member 73A, the second spacer member 73B, the third spacer member 73C, etc. The damping force adjusting part 60 also includes: the solenoid part 62 that applies thrust to the pressing member 63 (an example of a movable member) that can contact the side opposite to the side facing the control seat 76 in the control valve 70; and the coil spring 64 (an example of a first spring member), one end of which is in contact with the control valve 70 and the other end of which is in contact with the pressing member 63. In addition, the damping force adjusting part 60 includes the plate-shaped biasing member 75 (an example of a second spring member), one end of which is in contact with the control valve 70 and the other end of which is fixed to the case member (for example, between the first spacer member 73A and the third spacer member 73C).

According to the damping force adjusting part 60, in the pressing member 63, to which the thrust of the solenoid unit 62 is applied, in the region where the pressing member 63 comes into contact with the control valve 70 from a state where the pressing member 63 and the control valve 70 are separated by the action of the coil spring 64, the biasing member 75 is stiffer than the coil spring 64, and therefore, the position in the second axial direction of the control valve 70 remains unchanged, and the solenoid thrust is used only to deform the coil spring 64. In other words, the solenoid thrust is not used anywhere else, and there is little waste in the thrust efficiency of the solenoid part 62.

In addition, the pressing member 63 has the flange part 633 (an example of a restriction part) which restricts the flow path that flows through the second opening part 67H2 and the cap flow path 67R, which are the flow path downstream of the control valve 70, and the in-housing flow path 111 into the reservoir chamber R, and the other end of the coil spring 64 contacts the flange part 633. Therefore, for example, in the abnormal state, it is possible to press the pressing member 63 against the cap part 67 with high accuracy.

### Second Exemplary Embodiment

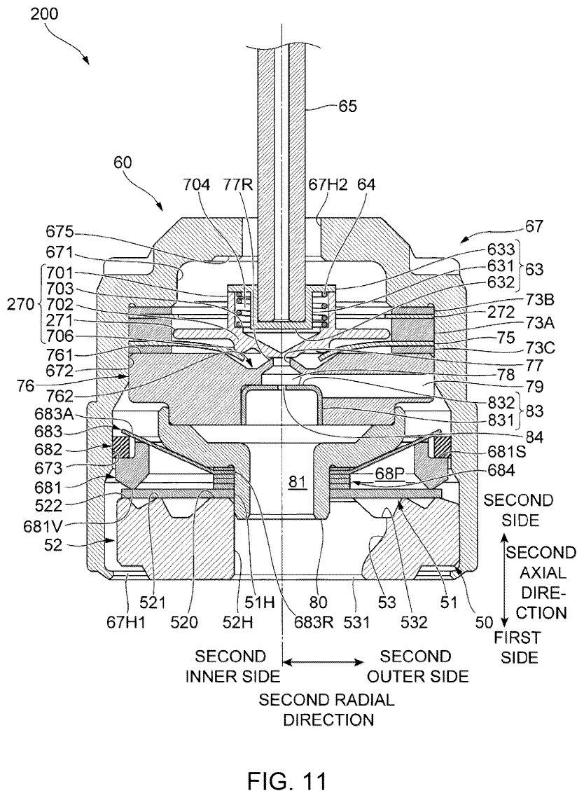

FIG. 11 is a diagram showing an example of an overall configuration of a damping force generation device 200 related to a second exemplary embodiment.

The damping force generation device 200 related to the second exemplary embodiment differs from the damping force generation device 100 related to the first exemplary embodiment in a control valve 270 corresponding to the control valve 70 and a regulation member 272 corresponding to the regulation member 72. Hereinafter, the points that differ from the first exemplary embodiment will be described. In the first and second exemplary embodiments, the same reference signs are used for the same components, and detailed descriptions thereof are omitted.

The regulation member 272 differs from the regulation member 72 in that the regulation member 272 does not have the arm parts 722 and only has a part corresponding to the annular part 721. Then, the inner diameter of the regulation member 272 is smaller than those of the first spacer member 73A and the second spacer member 73B, and the regulation member 272 protrudes toward the second inner side than the first spacer member 73A and the second spacer member 73B.

The control valve 270 differs from the control valve 70 in a protruding part 271 corresponding to the protruding part 71. Unlike the protruding part 71, the protruding part 271 is not formed around the entire circumference, but the plural (for example, four) protruding parts 271 are formed around the cylindrical part 701. The plural protruding parts 271 are provided at regular intervals in the circumferential direction of the cylindrical part 701. The size of the protruding part 271 in the circumferential direction gradually decreases from the second inner side toward the second outer side. The diameter of the virtual circle formed by the tip end of the second outer side at the plural protruding parts 271 is larger than the inner diameter of the regulation member 272 and smaller than the inner diameter of the first spacer member 73A and the second spacer member 73B.

In the damping force generation device 200 configured as described above, even if the control valve 270 has moved toward the second side upon receiving the pressure of the oil passing through the back pressure flow path 77, the control valve 270 is prevented from moving toward the second side by the protruding parts 271 coming into contact with the regulation member 272.

As described above, the damping force generation device 200 includes the valve 700 that is provided on the back pressure flow path 77 and has the conical part 702 of the control valve 270 (an example of the valve body) which varies the area of the back pressure flow path 77 and the control seat 76 (an example of the valve seat) on which the control valve 70 can be seated. In addition, the damping force generation device 200 includes the protruding parts 271 that regulate the movement of the control valve 270 so that the pressing member 63 does not reach the second position even if the control valve 270 moves in the direction that the pressing member 63 moves toward the second position due to the pressure of the oil passing through the back pressure flow path 77. In other words, the damping force generation device 200 includes a housing that is formed in a tubular shape to accommodate the pressing member 63 and the control valve 270, and protrusions are formed on the inner circumferential surface. In other words, an object constituted by the cap part 67, the first spacer member 73A and the second spacer member 73B, etc. is formed into a tubular shape that accommodates the pressing member 63 and the control valve 270, as well as the regulation member 272 protrudes toward the second inner side than the inner circumferential surface of the first spacer member 73A and the second spacer member 73B. Then, the regulation member 272 and the protruding parts 271 of the control valve 270 function as an example of the regulation part that regulates the movement of the conical part 702 of the control valve 270 toward the second position in a third position between the first position and the second position. According to the damping force generation device 200 configured as described above, in the normal state in which the mechanism can operate normally, even if the pressure of the oil passing through the back pressure flow path 77 is high, the abnormal state operations are suppressed.

### Third Exemplary Embodiment

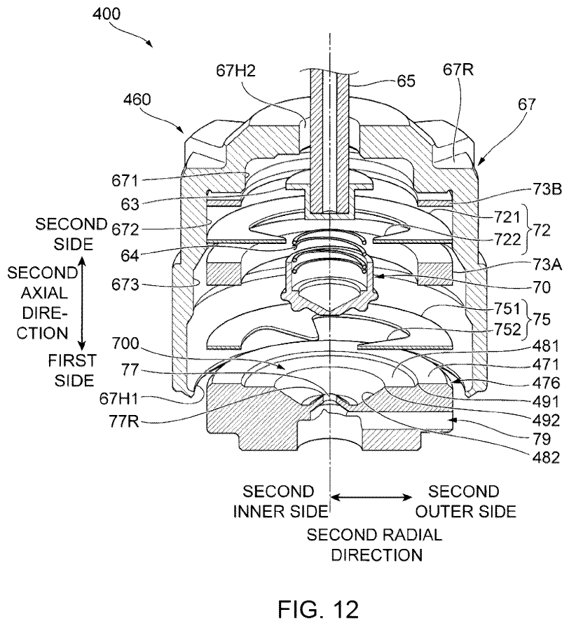

FIG. 12 is a diagram showing an example of an overall configuration of a damping force generation device 400 related to a third exemplary embodiment.

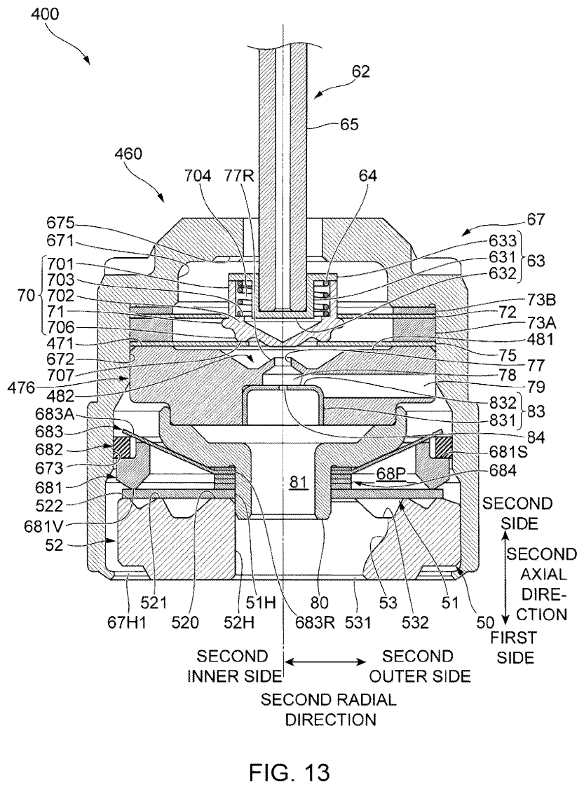

FIG. 13 is a diagram showing an example of a partial cross section of the damping force generation device 400 in the third exemplary embodiment.

The damping force generation device 400 related to the third exemplary embodiment differs from the damping force generation device 100 related to the first exemplary embodiment in a damping force adjusting part 460 corresponding to the damping force adjusting part 60. Hereinafter, the points that differ from the first exemplary embodiment will be described. In the first and third exemplary embodiments, the same reference signs are used for the same components, and detailed descriptions thereof are omitted.

The damping force adjusting part 460 related to the third exemplary embodiment differs from the damping force adjusting part 60 related to the first exemplary embodiment in a control seat 476 corresponding to the control seat 76. In addition, compared to the damping force adjusting part 60, the difference is that the damping force adjusting part 460 does not have the third spacer member 73C, and the first spacer member 73A and the control seat 476 fix the biasing member 75.

In the control seat 476, in the second radial direction, between a fixing portion 471 which is a portion for fixing the biasing member 75 and the round 77R where the control valve 70 can be seated, a first concave part 481 which is annularly recessed toward the first side than the fixing portion 471 and a second concave part 482 which is annularly recessed toward the first side on the second inner side than the first concave part 481 are formed. A first edge part 491 is formed at the edge of the opening part on the second side of the first concave part 481, and a second edge part 492 is formed at the edge of the opening part on the second side of the second concave part 482. The first edge part 491 is located slightly closer to the second inner side than the fixing portion 471, and the second edge part 492 is a connecting portion between the first concave part 481 and the second concave part 482.

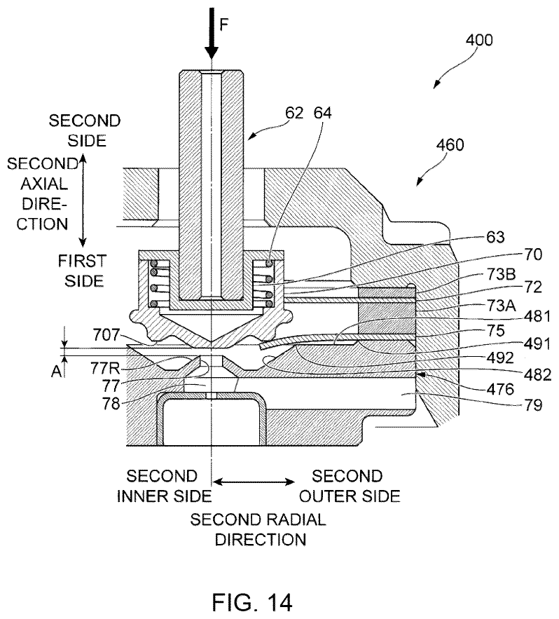

FIG. 14 is a diagram showing an example of a state where the biasing member 75 is in contact with the first edge part 491 and not in contact with the second edge part 492.

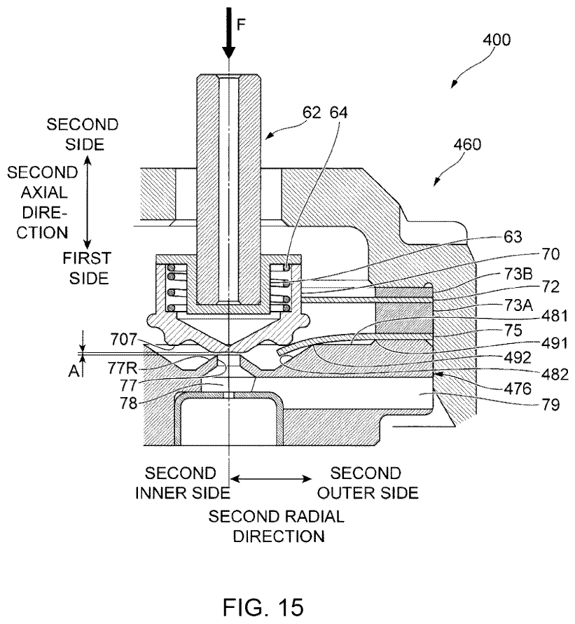

FIG. 15 is a diagram showing an example of a state where the biasing member 75 is in contact with the first edge part 491 and the second edge part 492.

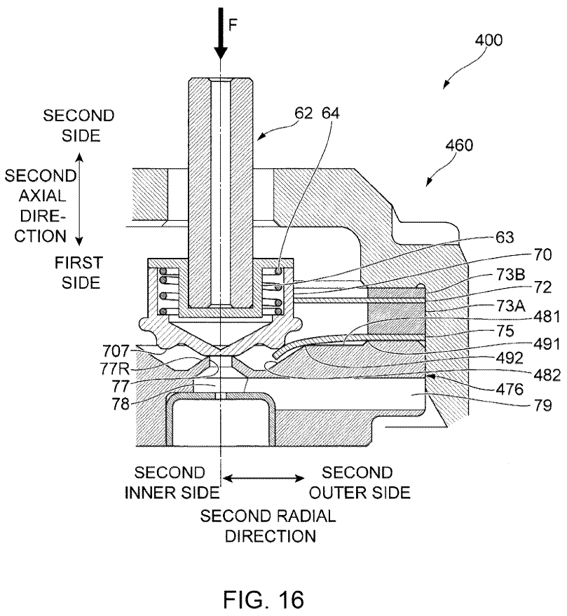

FIG. 16 is a diagram showing an example of a state where the control valve 70 is seated at the round 77R.

In the case where the supply current to the coil of the solenoid part 62 is a first current, which is a low current, the control valve 70 receives a force from the biasing member 75 toward the second side, and the spring force of the coil spring 64, the spring force of the biasing member 75, and the solenoid thrust are balanced as shown in FIG. 13. In addition, in the present invention, which is not limited to this third exemplary embodiment, as described above, when the supply current to the coil of the solenoid part 62 is between zero and the first current, all of the solenoid thrust is used to deform the coil spring 64; therefore, the thrust efficiency is good. In this state, the biasing member 75 does not bend, and the flat surface 707 of the control valve 70 and the biasing member 75 are brought into surface contact.

When the supply current to the solenoid part 62 becomes a second current larger than the first current, the biasing member 75 is pressed by the control valve 70 and bends to come into contact with the first edge part 491 of the control seat 476, as shown in FIG. 14.

When the supply current to the solenoid part 62 becomes a third current larger than the second current, the biasing member 75 is pressed by the control valve 70 and bends further, and is brought into contact with the first edge part 491 and the second edge part 492 of the control seat 476, as shown in FIG. 15.

When the supply current to the solenoid part 62 becomes a fourth current larger than the third current, the biasing member 75 is pressed by the control valve 70 and bends further, and the control valve 70 is seated on the round 77R, as shown in FIG. 16.

In other words, the supply current to the solenoid part 62 where the biasing member 75 begins to contact the first edge part 491 is the second current, and the supply current to the solenoid part 62 where the biasing member 75 begins to contact the second edge part 492 is the third current. In addition, the supply current to the solenoid part 62 where the control valve 70 begins to be seated on the round 77R is the fourth current.

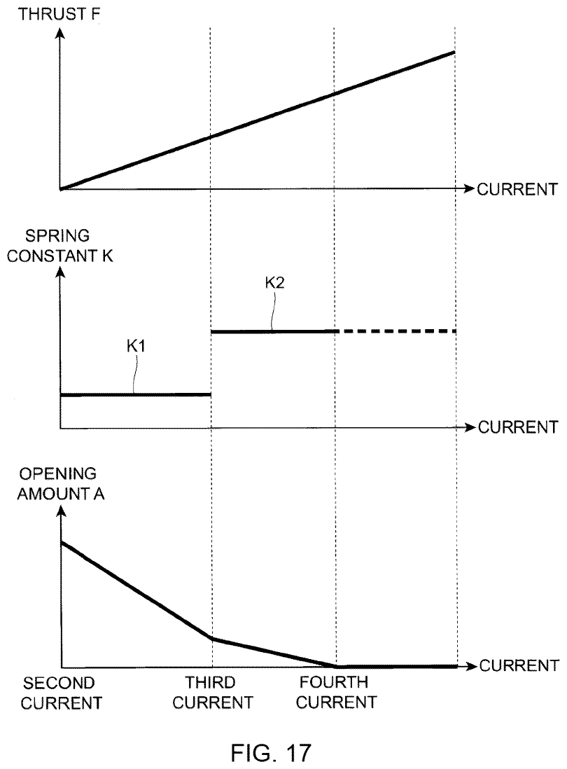

FIG. 17 is a diagram showing an example of the correlation between the supply current to the solenoid part 62 and each of the thrust F (see FIGS. 14 to 16) of the solenoid part 62, the spring constant K of the biasing member 75, and the opening amount A (see FIGS. 14 and 15) of the control valve 70.

In the case where the supply current to the solenoid part 62 is larger than or equal to the second current and smaller than the third current, the biasing member 75 bends from the first edge part 491 as a starting point, and in the case where the supply current to the solenoid part 62 is larger than or equal to the third current, the biasing member 75 bends from the second edge part 492 as a starting point. Therefore, as shown in FIG. 17, the spring constant K2 in the case of bending from the second edge part 492 as the starting point is substantially larger than the spring constant K1 in the case of bending from the first edge part 491 as the starting point. In this way, the biasing member 75 changes so that the spring constant K increases substantially as the control valve 70 moves toward the round 77R (an example of the valve seat). In addition, the amount of change in the valve opening amount A corresponding to an increase in the supply current (in other words, an increase in the thrust F of the solenoid part 62) in the case where the supply current to the solenoid part 62 is larger than or equal to the third current and smaller than the fourth current is smaller than the amount of change in the valve opening amount A corresponding to an increase in the supply current in the case where the supply current to the solenoid part 62 is larger than or equal to the second current and smaller than the third current. Therefore, in the case where the supply current to the solenoid part 62 is larger than or equal to the third current and smaller than the fourth current, the sensitivity in the actual position of the control valve 70 (in other words, the valve opening amount) corresponding to the supply current can be less than in the case where the supply current is larger than or equal to the second current and smaller than the third current. In addition, even in the case where the biasing member 75 is configured by a component other than the plate spring as described above, for example by using an unequal pitch coil spring, it is possible to configure the biasing member 75 to cause a change such that the spring constant K increases substantially as the control valve 70 moves toward the round 77R (an example of the valve seat).

As described above, in the damping force adjusting part 460 of the third exemplary embodiment, the control seat 476 has the first concave part 481 which is annularly recessed toward the round 77R side on the second inner side than the fixing portion 471 of the biasing member 75, and the second concave part 482 which is annularly recessed toward the round 77R side on the inner side than the first concave part 481. The biasing member 75 does not contact the first edge part 491, which is the edge of the first concave part 481, and the second edge part 492, which is the edge of the second concave part 482, in the case where the amount of movement of the control valve 70 toward the round 77R is less than or equal to a first predetermined value. The amount of movement of the control valve 70 toward the round 77R is based on the position as a reference where the movement of the control valve 70 toward the second side is regulated by the regulation member 72. Then, the first predetermined value is a distance from the reference to a position where the spring force of the coil spring 64 and the spring force of the biasing member 75 are balanced with very little bending of the biasing member 75 while the supply current to the solenoid part 62 is the first current. Moreover, the biasing member 75 contacts the first edge part 491 and does not contact the second edge part 492 in the case where the amount of movement of the control valve 70 toward the first side is larger than the first predetermined value and smaller than a second predetermined value. In other words, in the case where the supply current to the solenoid part 62 is larger than or equal to the second current and smaller than the third current, the biasing member 75 contacts the first edge part 491 and does not contact the second edge part 492. In addition, the biasing member 75 contacts the first edge part 491 and the second edge part 492 in the case where the amount of movement of the control valve 70 toward the first side is larger than or equal to the second predetermined value. In other words, the biasing member 75 contacts the first edge part 491 and the second edge part 492 in the case where the supply current to the solenoid part 62 is larger than or equal to the third current. The second predetermined value is a distance from the reference to the position of the control valve 70 when the biasing member 75 comes to a position to begin contacting the second edge part 492, while the supply current to the solenoid part 62 is the third current. According to the damping force adjusting part 460 configured as described above, the spring constant K of the biasing member 75 can be changed in the stepwise manner, and the damping force can be adjusted finely.

Here, as shown in FIG. 12, the biasing member 75 includes: the annular part 751 as an example of a fixed part serving as a fixed end; and the arm parts 752 as an example of plural acting parts extending from the annular part 751 toward the control valve 70 to contact the control valve 70 at the same time. This allows the biasing member 75 to form a flow path between the adjacent arm parts 752 from the back pressure flow path 77 toward the second opening part 67H2 even when the biasing member 75 applies the force to the control valve 70.

Note that, in the damping force adjusting part 460 related to the third exemplary embodiment, the first concave part 481 and the second concave part 482 are formed in the control seat 476 but are not limited to such mode. Similar to the damping force adjustment part 60 related to the first exemplary embodiment, the first concave part 481, which is recessed toward the first side from the contact portion with the biasing member 75, may be formed by providing the third spacer member 73C between the control seat 476 and the biasing member 75.

In addition, the position of the second axis direction in the first edge part 491, which is the starting point of bending of the biasing member 75, is the same position throughout the entire circumference, but is not limited to such mode. The first concave part 481 may be formed so that the position of the second axial direction in the first edge part 491 differs in the circumferential direction in the stepwise manner or in the continuous manner. In the same way, the first concave part 481 may be formed so that the position of the second radial position in the first edge part 491 differs in the circumferential direction in the stepwise manner or in the continuous manner. This makes it possible to change the spring constant K1, in the case where the biasing member 75 bends from the first edge part 491 as the starting point, in the stepwise manner or in the continuous manner. In other words, the first concave part 481 may not have a single recess size in the second axial direction or a single position in the second radial direction.

Similarly, the position of the second axis direction in the second edge part 492, which is the starting point of bending of the biasing member 75, is the same position throughout the entire circumference, but is not limited to such mode. The second concave part 482 may be formed so that the position of the second axial direction in the second edge part 492 differs in the circumferential direction in the stepwise manner or in the continuous manner. In the same way, the second concave part 482 may be formed so that the position of the second radial position in the second edge part 492 differs in the circumferential direction in the stepwise manner or in the continuous manner. This makes it possible to change the spring constant K2, in the case where the biasing member 75 bends from the second edge part 492 as the starting point, in the stepwise manner or in the continuous manner. In other words, the second concave part 482 may not have a single recess size in the second axial direction or a single position in the second radial direction.

### REFERENCE SIGNS LIST

1 Hydraulic shock absorbing device
10 Cylinder part
11 Cylinder
20 Rod
30 Piston part
51 Main valve (an example of the main valve)
60, 460 Damping force adjusting part
62 Solenoid part (an example of the actuator part)
63 Pressing member (an example of the movable member)
64 Coil spring (an example of the moving member, an example of the first spring member)
65 Plunger
67 Cap part (an example of a case member)
68P Back pressure chamber
70 Control valve (an example of the valve body)
72 Regulation member (an example of the regulation part)
75 Biasing member (an example of the second spring member)
76, 476 Control seat (an example of the valve seat, an example of the case member)
77 Back pressure flow path (an example of a flow path)
77R Round (an example of the valve seat)
100, 200, 400 Damping force generation device
270 Control valve
271 Protruding part (an example of the regulation part)
471 Fixing portion
481 First concave part
482 Second concave part
491 First edge part
492 Second edge part
631 Cylindrical part
632 Bottom part
633 Flange part (an example of the restriction part)
700 Valve
702 Conical part (an example of the valve body)
751 Annular part (an example of the fixed part)
752 Arm part (an example of the acting part)

What is claimed is:

1. A damping force adjusting device comprising:
a valve body provided on a flow path through which a fluid flows and capable of changing an area of the flow path;
a case member housing the valve body and including a valve seat with a through hole formed therein, the through hole capable of being closed by the valve body;
an actuator part applying thrust to a movable member capable of contacting a side of the valve body opposite to a side thereof facing the valve seat;
a first spring member having one end in contact with the valve body and the other end in contact with the movable member; and
a second spring member having one end in contact with the valve body and the other end fixed to the case member.

2. The damping force adjusting device according to claim 1, wherein
the movable member includes a restriction part restricting the flow path downstream of the valve body, and
the other end of the first spring member contacts the restriction part.

3. The damping force adjusting device according to claim 1, wherein a spring constant of the second spring member changes as the valve body moves toward the valve seat.

4. The damping force adjusting device according to claim 3, wherein the second spring member is configured with a plate spring and deforms in a direction in which the spring constant increases by a change in a contact position with the case member as the valve body moves toward the valve seat.

5. The damping force adjusting device according to claim 1, wherein,
in the case member, a first concave part which is annularly recessed toward the valve seat on an inner side than a fixing portion of the second spring member and a second concave part which is annularly recessed toward the valve seat on an inner side than the first concave part are formed, and
the second spring member does not contact a first edge part, which is an edge of the first concave part, and a second edge part, which is an edge of the second concave part, when an amount of movement of the valve body toward the valve seat is smaller than or equal to a first predetermined value, contacts the first edge part but does not contact the second edge part when the amount of movement is larger than the first predetermined value and smaller than a second predetermined value, and contacts the first edge part and the second edge part when the amount of movement is larger than or equal to the second predetermined value.

6. The damping force adjusting device according to claim 5, wherein the second spring member includes a fixed part serving as a fixed end and at least one acting part extending from the fixed part toward the valve body and contacts the valve body.

7. The damping force adjusting device according to claim 6, wherein the second spring member contacts the first edge part and the second edge part with the acting part.

8. A shock absorbing device comprising:
a piston part inserted into a cylinder filled with fluid and capable of moving with respect to the cylinder; and
the damping force adjustment device according to claim 1 adjusting a damping force generated by use of a flow of the fluid caused by the movement of the piston part.
